(19) United States
(12) Patent Application Publication
(10) Pub. No.: US 2021/0154890 A1
(43) Pub. Date: May 27, 2021

(54) WORKPIECE MANUFACTURING SYSTEM AND WORKPIECE MANUFACTURING METHOD

(71) Applicant: TOYOTA JIDOSHA KABUSHIKI KAISHA, Toyota-shi (JP)

(72) Inventor: Takashi SAKUI, Nagoya-shi (JP)

(73) Assignee: TOYOTA JIDOSHA KABUSHIKI KAISHA, Toyota-shi (JP)

(21) Appl. No.: 17/080,190

(22) Filed: Oct. 26, 2020

(30) Foreign Application Priority Data
Nov. 21, 2019 (JP) 2019-210693

(51) Int. Cl. B29C 35/02; B29C 70/54

(52) U.S. Cl. CPC B29C 35/0238; B29K 2307/04; B29C 70/54; B29C 35/0288

(57) ABSTRACT

A method for manufacturing a workpiece, capable of greatly reducing a heating time is provided. A workpiece manufacturing system according to an embodiment includes a heating apparatus configured to heat a workpiece containing, as its material, a carbon fiber reinforced plastic containing a carbon fiber and a resin. The heating apparatus includes a steam heating unit configured to heat at least a part of the workpiece including its surface to a temperature higher than a softening temperature of the carbon fiber reinforced plastic by bringing superheated steam into contact with the surface of the workpiece, and a heat-transfer member configured to be inserted into the part of the workpiece including the surface whose temperature has reached the softening temperature and thereby directly heat an inside of the workpiece.

### CROSS REFERENCE TO RELATED APPLICATIONS

This application is based upon and claims the benefit of priority from Japanese patent application No. 2019-210693, filed on Nov. 21, 2019, the disclosure of which is incorporated herein in its entirety by reference.

### BACKGROUND

The present disclosure relates to a workpiece manufacturing system and a workpiece manufacturing method.

Japanese Unexamined Patent Application Publication No. 2016-075466 discloses a method for manufacturing a workpiece, including a step of filling space around a (metallic) workpiece with superheated steam and thereby heating the workpiece through heat transfer from the superheated steam.

### SUMMARY

When the workpiece contains carbon fibers and a resin, such as containing carbon fiber reinforced plastics (hereinafter referred to as CFRP), the heat transfer efficiency is significantly reduced, so that it requires a long time to heat the workpiece.

The present disclosure has been made in order to solve the above-described problem, and provides a workpiece manufacturing system and a workpiece manufacturing method capable of greatly reducing a heating time.

A first exemplary aspect is a workpiece manufacturing system including a heating apparatus configured to heat a workpiece containing a carbon fiber reinforced plastic containing a carbon fiber and a resin as its material, in which the heating apparatus includes: a steam heating unit configured to heat at least a part of the workpiece including its surface to a temperature higher than a softening temperature of the carbon fiber reinforced plastic by bringing superheated steam into contact with the surface of the workpiece; and a heat-transfer member configured to be inserted into the part of the workpiece including the surface whose temperature has reached the softening temperature and thereby directly heat an inside of the workpiece. By the above-described configuration, the heating time can be greatly shortened.

Further, the heat-transfer member includes a superheated-steam nozzle configured to spout out the superheated steam. By the above-described configuration, since the inside of the workpiece can be directly heated, the heating time can be greatly shortened.

Further, the heat-transfer member includes a heater. By the above-described configuration, since the inside of the workpiece can be directly heated, the heating time can be greatly shortened.

Further, the workpiece manufacturing system includes a thermometer configured to measure a surface temperature of the workpiece; a temperature sensor configured to measure an internal temperature of the workpiece; and a control unit configured to control an output of the steam heating unit and the heat-transfer member based on the surface temperature and the internal temperature. The control part controls a depth of insertion of the heat-transfer member and the temperature sensor into the workpiece based on the internal temperature. By the above-described configuration, the heating time can be further reduced.

Another exemplary aspect is a method for manufacturing a workpiece, including a heating step of heating the workpiece containing a carbon fiber reinforced plastic containing a carbon fiber and a resin as its material, in which the heating step includes: a steam heating step of heating at least a part of the workpiece including its surface to a temperature higher than a softening temperature of the carbon fiber reinforced plastic by bringing superheated steam into contact with the surface of the workpiece; and a direct heating step of inserting a heat-transfer member into the part of the workpiece including the surface whose temperature has reached the softening temperature and thereby directly heating an inside of the workpiece. By the above-described configuration, the heating time can be greatly shortened.

Further, in the direct heating step, a superheated-steam nozzle configured to spout out the superheated steam is inserted as the heat-transfer member. By the above-described configuration, since the inside of the workpiece can be directly heated, the heating time can be greatly shortened.

Further, in the direct heating step, a heater is inserted as the heat-transfer member. By the above-described configuration, since the inside of the workpiece can be directly heated, the heating time can be greatly shortened.

Further, in the steam heating step, a temperature of the superheated steam is controlled based on a surface temperature of the workpiece measured by a thermometer. In the direct heating step, an output of the heat-transfer member is controlled based on an internal temperature of the workpiece measured by a temperature sensor, and a depth of insertion of the heat-transfer member and the temperature sensor into the workpiece is also controlled based on the internal temperature. By the above-described configuration, the heating time can be further reduced.

According to the present disclosure, it is possible to provide a workpiece manufacturing system and a workpiece manufacturing method capable of greatly reducing a heating time.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a configuration diagram showing an example of a heating apparatus in a workpiece manufacturing system according to an embodiment;

FIG. 2 is a top view showing an example of a heat-transfer member that heats a workpiece in a workpiece manufacturing system according to an embodiment;

FIG. 3 is a flowchart showing an example of a heating step of heating a workpiece in a method for manufacturing a workpiece according to an embodiment;

FIG. 4 is a flowchart showing an example of a steam heating step in a method for manufacturing a workpiece according to an embodiment;

FIG. 5 shows an example of a graph for imaginary control of a heating temperature in a method for manufacturing a workpiece according to an embodiment;

FIG. 6 is a graph showing an example of a surface temperature and an internal temperature of a workpiece in a method for manufacturing a workpiece according to an embodiment, in which a horizontal axis indicates time and a vertical axis indicates the surface temperature and the internal temperature;

FIG. 7 is a flowchart showing an example of a direct heating step in a method for manufacturing a workpiece according to an embodiment;

FIG. 8 shows an example of a state in which a heat-transfer member is inserted into a workpiece in the method for manufacturing the workpiece according to the embodiment;

FIG. 9 shows an example of a state in which a heat-transfer member is inserted into a workpiece in a method for manufacturing a workpiece according to a modified example 1 of an embodiment; and

FIG. 10 shows an example of a state in which a heat-transfer member is inserted into a workpiece in a method for manufacturing a workpiece according to a modified example 2 of an embodiment.

### DESCRIPTION OF EMBODIMENTS

Specific embodiments for implementing the present disclosure will be described hereinafter with reference to the drawings. However, the present disclosure is not limited to the below-shown embodiments. Further, the following descriptions and drawings are simplified as appropriate for clarifying the explanation. For making the drawings simpler, part of hatching and some of symbols are omitted as appropriate.

### Embodiment

A workpiece manufacturing system and a workpiece manufacturing method according to an embodiment will be described. Firstly, a configuration of a workpiece manufacturing system will be described. After that, a method for manufacturing a workpiece using the workpiece manufacturing system will be described.

(Configuration of Workpiece Manufacturing System)

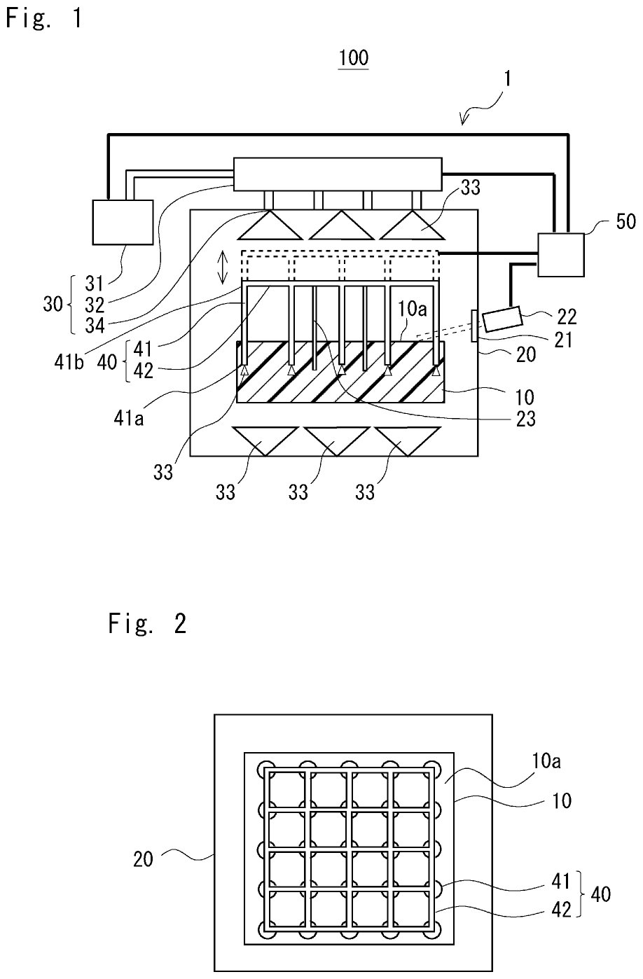

FIG. 1 is a block diagram showing an example of a heating apparatus in a workpiece manufacturing system according to an embodiment. FIG. 2 is a top view showing an example of a heat-transfer member that heats a workpiece in the workpiece manufacturing system according to the embodiment. As shown in FIGS. 1 and 2, the workpiece manufacturing system 100 includes a heating apparatus 1. In addition to the heating apparatus 1, the workpiece manufacturing system 100 may include other apparatuses necessary for manufacturing a workpiece 10, such as a molding apparatus. An overview of the heating apparatus 1 will be described below. After that, a configuration of the workpiece 10, which is an object to be heated by the heating apparatus 1, and a configuration of the heating apparatus 1 will be described.

<Heating Apparatus>

The heating apparatus 1 heats a workpiece 10 containing CFRP (Carbon Fiber Reinforced Plastics). The heating apparatus 1 includes a chamber 20, a steam heating unit 30, a heat-transfer member 40, and a control unit 50 as components for heating the workpiece 10. Further, the heating apparatus 1 may also include a thermometer 22 and a temperature sensor 23.

<Workpiece>

The workpiece 10 contains, for example, CFRP. The CFRP contains carbon fibers and a resin as its material. There are two types of CFRP, for example, thermoplastic CFRP and thermosetting CFRP. The thermoplastic CFRP has such a property that it gradually changes from a hardened state to a softened state as its temperature rises from a low temperature to a high temperature. Note that a temperature at which the thermoplastic CFRP softens and begins to deform as its temperature rises is called a softening temperature. In contrast, the thermosetting CFRP has such a property that it gradually changes from a softened state to a hardened state as its temperature rises from a low temperature to a high temperature. The workpiece 10 in this embodiment includes, for example, the thermoplastic CFRP.

The workpiece 10 has, for example, a plate-like shape. In this case, the workpiece 10 has a flat plate surface. The plate surface is called a flat surface part 10a. The length in a direction perpendicular to the plate surface is called a thickness. Alternatively, the workpiece 10 may have a block-like shape such as a cubic shape. In this case, the length of the smallest side is called a thickness. A surface perpendicular to the direction in which the smallest side extends is referred to as a flat surface part 10a. When the workpiece 10 is heated, the workpiece 10 is placed inside the chamber 20.

<Chamber>

The chamber 20 is a container that houses the workpiece 10 as an object to be heated. The inside of the chamber 20 is, for example, hermitically sealed. The chamber 20 is connected to the steam heating unit 30. The inside of the chamber 20 can be filled with superheated steam 33 when the workpiece 10 is heated. Heat-resistant glass 21 may be provided in a part of a wall of the chamber 20. The thermometer 22 such as a radiation thermometer measures the surface temperature of the workpiece 10 through the heat-resistant glass 21.

Note that when the internal temperature of the workpiece 10 is measured, for example, the temperature sensor 23 is inserted into the workpiece 10 and the internal temperature of the workpiece 10 is measured. Further, a plurality of radiation thermometers, temperature sensors, and the like that measure the surface temperature and the internal temperature of the workpiece 10 may be provided. The thermometer 22 and the temperature sensor 23 are connected to the control unit 50, for example, through information transmission means such as signal lines and output information about acquired temperatures to the control unit 50.

<Steam Heating Unit>

The steam heating unit 30 heats the workpiece 10 to a temperature higher than the softening temperature of the CFRP by using superheated steam 33. Specifically, the steam heating unit 30 spouts out the superheated steam 33 into the chamber 20. Further, the steam heating unit 30 fills the inside of the chamber 20 with the superheated steam 33. In this way, the steam heating unit 30 heats at least a part of the workpiece 10 including its surface to a temperature higher than the softening temperature of the CFRP by bringing the superheated steam 33 into contact with the surface of the workpiece 10.

The steam heating unit 30 includes, for example, a boiler 31, a superheated-steam generator 32, and a superheated-steam spouting unit 34. Note that the steam heating unit 30 may include a member(s) other than the boiler 31, the superheated-steam generator 32, and the superheated steam spouting unit 34, or may not includes at least one of the boiler 31, the superheated-steam generator 32, and the superheated steam spouting unit 34, provided that the steam heating unit 30 can heat at least a part of the workpiece 10 including its surface to a temperature higher than the softening temperature of the CFRP.

The superheated-steam generator 32 is an apparatus that generates superheated steam 33. The superheated-steam generator 32 further heats saturated steam generated by the boiler 31 and thereby generates high-temperature superheated steam 33. The generated superheated steam 33 is spouted out from the superheated steam spouting unit 34 disposed inside the chamber 20 to the surface of the workpiece 10. In the drawing, illustration of a pipe(s) that connects the superheated-steam generator 32 to the superheated steam spouting unit 34 is omitted.

The boiler 31 and the superheated-steam generator 32 are connected to the control unit 50, for example, through information transmission means such as signal lines, so that the amount, the temperature, and the like of generated steam are controlled by the control unit 50.

<Heat-transfer Member>

The heat-transfer member 40 is disposed inside the chamber 20. The heat-transfer member 40 is inserted into a part of the workpiece 10 including its surface, whose temperature has already reached the softening temperature. Then, the heat-transfer member 40 directly heats the inside of the workpiece 10. The heat-transfer member 40 includes, for example, a superheated-steam nozzle from which superheated steam 33 is spouted out. In this case, the heat-transfer member 40 spouts out the superheated steam 33 from the superheated-steam nozzle inserted into the workpiece 10 and thereby directly heats the inside of the workpiece 10. Alternatively, the heat-transfer member 40 may include, for example, a heater. In this case, the heat-transfer member 40 directly heats the inside of the workpiece 10 by heat generated by the heater inserted into the workpiece 10.

The heat-transfer member 40 includes, for example, insertion parts 41 and a connection part 42. A plurality of insertion parts 41 are provided in the heat-transfer member 40. Each of the insertion parts 41 is a tubular or rod-like member. For example, each of the insertion parts 41 is disposed above the flat surface part 10a of the workpiece 10 and extends in the vertical direction perpendicular to the flat surface part 10a. One end 41a of each of the insertion parts 41 is located at a lower place and is positioned so as to be opposed to the workpiece 10. The other end 41b of each of the insertion parts 41 is located at a higher place and is connected to the connection part 42. The connection part 42 includes a plurality of tubular or rod-like members. The plurality of rod-like or tubular members of the connection part 42 are arranged in a lattice pattern on a horizontal plane parallel to the flat surface part 10a. The other end 41b of each of the insertion parts 41 is connected to an intersection in the lattice constituting the connection part 42.

When the heat-transfer member 40 includes the superheated-steam nozzle, for example, the insertion parts 41 and the connection part 42 are formed by tubular members. Further, superheated steam 33 generated by the superheated-steam generator 32 passes through the tubes of the connection part 42 and the insertion parts 41 and is spouted out from the one end 41a of each of the insertion parts 41. When the heat-transfer member 40 includes the heater, for example, each of the insertion parts 41 is a rod-like heater. Further, an electric current is supplied from a power supply (not shown) to the insertion parts 41 through the connection part 42. By inserting the heat-transfer member 40 into the softened workpiece 10, the inside of the workpiece 10 can be directly heated by the superheated steam 33 or the heat generated by the heater.

The temperature sensor 23 that measures the internal temperature of the workpiece 10 may be attached to the heat-transfer member 40. By using the above-described configuration, it is possible, when the heat-transfer member 40 is inserted into the workpiece 10, to insert the temperature sensor 23 into the workpiece 10 together with the heat-transfer member 40.

The heat-transfer member 40 is connected to the control unit 50, for example, through information transmission means such as signal lines. The operation for inserting the heat-transfer member 40 and the temperature sensor 23 into the workpiece 10, the operation for removing them from the workpiece 10, the heating temperature by the heat-transfer member 40, and the like are controlled by the control unit 50.

<Control Unit>

The control unit 50 controls the outputs of the steam heating unit 30 and the heat-transfer member 40 based on the surface temperature and the internal temperature of the workpiece 10. The control unit 50 performs feedback-control for the steam heating unit 30 and the heat-transfer member 40 while monitoring the surface temperature and the internal temperature of the workpiece 10 by using the thermometer 22 and the temperature sensor 23 so that the surface temperature and the internal temperature reach a predetermined set temperature(s). In this way, it is possible to quickly heat the workpiece 10 according to the type of resin contained in the workpiece 10 irrespective of what type of the resin is contained in the workpiece 10.

Further, when the temperature of the workpiece 10 reaches a predetermined softening temperature, the control unit 50 controls the operation of the heat-transfer member 40 so as to insert the heat-transfer member 40 into the workpiece 10. Specifically, the control unit 50 inserts the heat-transfer member 40 into a part of the workpiece 10 including its surface that has already reached the softening temperature of the CFRP. Note that the control unit 50 may insert the temperature sensor 23 into the workpiece 10 together with the heat-transfer member 40. In this case, the control unit 50 controls the depth of the insertion of the heat-transfer member 40 and the temperature sensor 23 into the workpiece 10 based on the internal temperature.

<Work Manufacturing Method>

Next, a method for manufacturing a workpiece 10 will be described. The method for manufacturing a workpiece 10 includes a heating step of heating the workpiece 10 containing CFRP containing carbon fibers and a resin as its material. The method for manufacturing the workpiece 10 may include other steps necessary for manufacturing the workpiece 10, such as a molding step, in addition to the heating step. The heating step of heating the workpiece 10 will be described hereinafter with reference to a flowchart.

<Heating Step of Heating Workpiece>

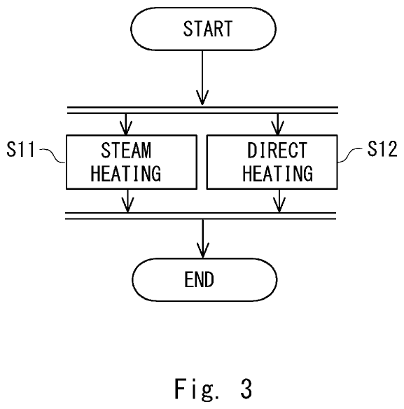

FIG. 3 is a flowchart showing an example of a heating step of heating a workpiece in a method for manufacturing a workpiece according to an embodiment. As shown in steps S11 and S12 in FIG. 3, the heating step of heating the workpiece 10 according to this embodiment includes a steam heating step and a direct heating step. The steam heating step is a step of heating at least a part of the workpiece 10 including its surface to a temperature higher than the softening temperature of the CFRP by bringing superheated steam 33 into contact with the surface of the workpiece 10. Further, the direct heating step is a step of directly heating the inside of the workpiece 10 by inserting the heat-transfer member 40 into the part of the workpiece 10 including its surface, whose temperature has already reached the softening temperature. Each of the aforementioned heating steps will be described hereinafter. Firstly, the steam heating step will be described.

<Steam Heating Step>

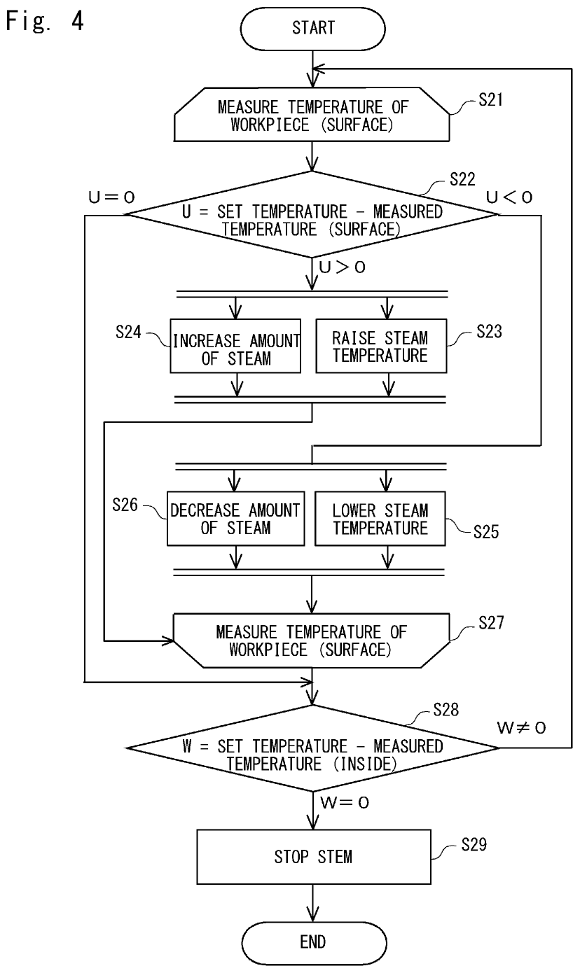

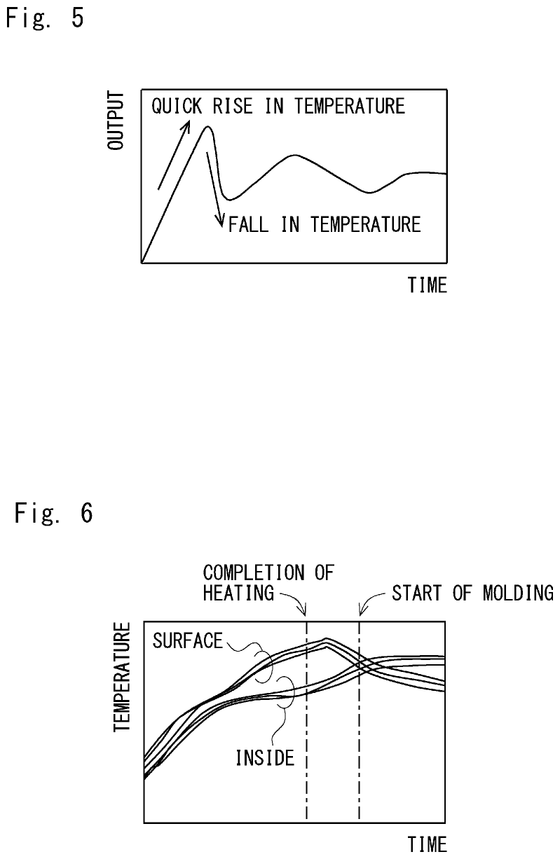

FIG. 4 is a flowchart showing an example of the steam heating step in the method for manufacturing a workpiece according to this embodiment. FIG. 5 shows an example of a graph for imaginary control of a heating temperature in the method for manufacturing a workpiece according to the embodiment.

Firstly, as shown in a step S21 in FIG. 4, the surface temperature of the workpiece 10 is measured. The surface temperature is measured, for example, by the thermometer 22 such as a radiation thermometer. Note that the measurement of the surface temperature of the workpiece 10 is not limited to the measurement by the non-contact-type thermometer 22 such as a radiation thermometer, and may be carried out by a contact-type thermometer 22. The temperature that has been measured is called a measured temperature.

Next, as shown in a step S22 in FIG. 4, a temperature difference U is calculated. The temperature difference U is a difference between the set temperature of the workpiece 10 and the measured temperature of the surface of the workpiece 10. For example, the set temperature is a temperature higher than the softening temperature of the CFRP contained in the workpiece 10. For example, the temperature difference U is calculated by the control unit 50.

When the temperature difference U is larger than zero (U>0), the control unit 50 controls the superheated-steam generator 32 of the steam heating unit 30 so as to raise the temperature of the steam as shown in steps S23 and S24 in FIG. 4. Further, the control unit 50 controls the boiler 31 of the steam heating unit 30 so as to increase the amount of the steam. The control unit 50 may simultaneously control the superheated-steam generator 32 and the boiler 31.

In this way, as shown in FIG. 5, the control unit 50 raises the temperature of the workpiece 10 by controlling the temperature and amount of the steam. After that, as shown in a step S27 in FIG. 4, the process returns to the step S21 in order to measure the surface temperature of the workpiece 10.

On the other hand, when the temperature difference U is smaller than zero (U<0) in the step S22, the control unit 50 controls the superheated-steam generator 32 so as to lower the temperature of the steam as shown in steps S25 and S26 in FIG. 4. Further, the control unit 50 controls the boiler 31 so as to reduce the amount of the steam. The control unit 50 may simultaneously control the superheated-steam generator 32 and the boiler 31. In this way, as shown in FIG. 5, the control unit 50 lowers the temperature of the workpiece 10 by controlling the temperature and amount of the steam. After that, as shown in a step S27, the process returns to the step S21 in order to measure the surface temperature of the workpiece 10.

When the temperature difference U is equal to zero (U=0) in the step S22, the control unit 50 calculates a temperature difference W as shown in a step S28 in FIG. 4. The temperature difference W is a difference between the set temperature of the workpiece 10 and the measured temperature of the inside of the workpiece 10 (which will be described later). When the temperature difference W is not equal to zero (W≠0), the process returns to the step S21 and the control unit 50 measures the surface temperature of the workpiece 10.

On the other hand, when the temperature difference W is equal to zero (W=0), the control unit 50 stops spouting out the superheated steam 33 as shown in a step S29 in FIG. 4. With this stop of the spouting (i.e., the injection), the steam heating step is finished.

As described above, in the steam heating step according to this embodiment, the control unit 50 controls the output of the steam heating unit 30 based on the surface temperature of the workpiece 10 measured by the thermometer 22. Note that depending on the material of the workpiece 10 and/or the condition for the subsequent molding process, the set temperature of the workpiece 10 when the temperature difference U is calculated may be different from the set temperature of the workpiece 10 when the temperature difference W is calculated.

Further, in order to eliminate (i.e., ignore) the situation where both the temperature differences U and W are temporarily zero (U=0 and W=0), for example, the situation where both the temperature differences U and W are temporarily zero (U=0 and W=0) as the temperatures increase and exceed the set temperature, the control unit 50 determines that both the temperature differences U and W are zero (U=0 and W=0) after confirming that both the temperature differences U and W remain zero (U=0 and W=0) over a predetermined duration. Further, both the temperature differences U and W being zero (U=0 and W=0) may include not only the situation where the temperature differences U and W are exactly zero, but also the situation where they are within predetermined error ranges.

FIG. 6 is a graph showing an example of a surface temperature and an internal temperature of a workpiece in a method for manufacturing a workpiece according to an embodiment, in which a horizontal axis indicates time and a vertical axis indicates the surface temperature (indicated as “SURFACE” in the graph) and the internal temperature (indicated as “INSIDE” in the graph). Note that a plurality of surface temperatures and a plurality of internal temperatures are measured.

As shown in FIG. 6, in the steam heating step of heating the workpiece 10 by the superheated steam 33, heat is transferred from the surface of the workpiece 10 to the inside thereof through heat conduction, so that the increase in the internal temperature of the workpiece 10 is slower than the increase in the surface temperature of the workpiece 10. For example, at the moment when the heating has been just completed, the surface temperature of the workpiece 10 is higher than the internal temperature of the workpiece 10.

Therefore, in this embodiment, after the CFRP contained in the workpiece 10 is softened, the heat-transfer member 40 is inserted into the workpiece 10 and the inside of the workpiece 10 is directly heated. By using such a direct heating step, the heating time can be greatly shortened.

Note that as shown in FIG. 6, when the workpiece 10 is taken out from the heating apparatus 1 after the completion of the heating, the surface temperature of the workpiece 10 decreases. However, the internal temperature of the workpiece 10 increases because of the heat conduction from the surface thereof. After the molding of the workpiece 10 is started, the surface temperature is lowered. Therefore, the internal temperature becomes higher than the surface temperature. That is, the relation between these temperatures is reversed.

<Direct Heating Step>

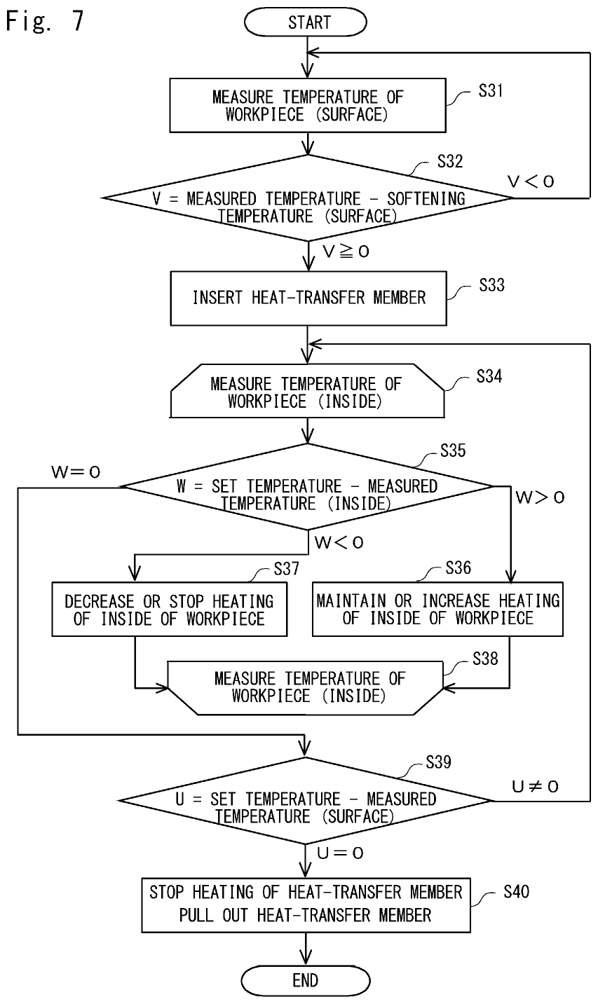

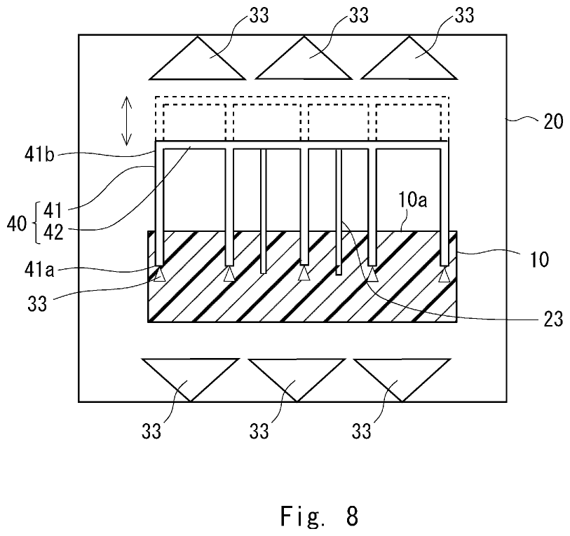

Next, the direct heating step will be described. FIG. 7 is a flowchart showing an example of the direct heating step in a method for manufacturing a workpiece according to an embodiment. FIG. 8 shows an example of a state in which the heat-transfer member 40 is inserted into the workpiece 10 in the method for manufacturing the workpiece according to the embodiment.

As shown in a step S31 in FIG. 7, firstly, the surface temperature of the workpiece 10 is measured. When the surface temperature of the workpiece 10 is measured, for example, the thermometer 22 such as a radiation thermometer is used. Note that the measurement of the surface temperature of the workpiece 10 is not limited to the measurement by the non-contact-type thermometer 22 such as a radiation thermometer, and may be carried out by a contact-type thermometer 22.

Next, as shown in a step S32 in FIG. 7, the control unit 50 calculates a temperature difference V. The temperature difference V is a difference between the measured temperature of the surface of the workpiece 10 and the softening temperature of the workpiece 10. The softening temperature is the softening temperature of the CFRP contained in the workpiece 10. When the temperature difference V is smaller than zero (V<0), the control unit 50 returns to the step S31 and continues measuring the temperature of the workpiece 10.

On the other hand, when the temperature difference V is equal to or larger than zero (V≥0), the heat-transfer member 40 is inserted into the workpiece 10 as shown in a step S33 in FIG. 7. For example, one end 41a of each of the insertion parts 41 of the heat-transfer member 40 is inserted into the workpiece 10 under the control of the control unit 50. The CFRP contained in the workpiece 10 softens at the softening temperature. As a result, the heat-transfer member 40 can be inserted into the workpiece 10.

As shown in FIG. 8, in the case where the superheated-steam nozzle that spouts out superheated steam 33 is inserted as the heat-transfer member 40, the inside of the workpiece 10 is heated by spouting out the superheated steam 33 from one end 41a of each of the insertion parts 41. For example, the spouting (i.e., the injection) of the superheated steam 33 is controlled by the controller 50. The heat-transfer member 40 is connected to the superheated-steam generator 32 which is used in the steam heating step. In this way, the superheated steam 33 generated by the superheated-steam generator 32, which is the substantially the same as that generated in the steam heating step, can be used. Therefore, it is possible to perform the direct heating step without adding any special device in the heating apparatus 1.

For example, when the heater is inserted as the heat-transfer member 40, the output or the like of the heater is controlled by the control unit 50.

Next, as shown in a step S34 in FIG. 7, the temperature of the workpiece 10 is measured. For example, the control unit 50 measures the internal temperature of the workpiece 10. When the internal temperature of the workpiece 10 is measured, for example, the temperature sensor 23 such as an insertion-type thermometer configured to be inserted into the workpiece 10 may be used.

Next, as shown in a step S35 in FIG. 7, the control unit 50 calculates a temperature difference W. The temperature difference W is a difference between the set temperature of the workpiece 10 and the measured temperature of the inside of the workpiece 10. When the temperature difference W is larger than zero (W>0), the control unit 50 maintains or increases the heating of the inside of the workpiece 10 as shown in a step S36. Specifically, in the case where the superheated-steam nozzle is used as the heat-transfer member 40: the temperature of the superheated steam 33 spouted out from the superheated-steam nozzle is raised; the amount of the superheated steam 33 is increased; or the spouting (i.e., the injection) of the superheated steam 33 is maintained. Alternatively, in the case where the heater is used as the heat-transfer member 40, the heating value of the heater is increased or maintained. How much and how long the heating should be increased, or whether the heating should be maintained or not is determined based on the value of the temperature difference W. Then, as shown in a step S38, the process returns to the step S34 in order to measure the temperature of the inside of the workpiece 10.

On the other hand, when the temperature difference W is smaller than zero (W<0), the control unit 50 reduces or stops the heating of the inside of the workpiece 10 as shown in a step S37. Specifically, in the case where the superheated-steam nozzle is used as the heat-transfer member 40: the temperature of the superheated steam 33 spouted out from the superheated-steam nozzle is lowered; the amount of the superheated steam 33 is decreased; or the spouting (i.e., the injection) of the superheated steam 33 is stopped. Alternatively, in the case where the heater is used as the heat-transfer member 40, the heating value of the heater is reduced or the heater is stopped. How much and how long the heating should be reduced, or whether the heating should be stopped or not is determined based on the value of the temperature difference W. Then, as shown in a step S38 in FIG. 7, the process returns to the step S34 in order to measure the temperature of the inside of the workpiece 10.

Further, when the temperature difference W is equal to zero (W=0), the control unit 50 calculates a temperature difference U as shown in a step S39 in FIG. 7. The temperature difference U is a difference between the set temperature of the workpiece 10 and the measured temperature of the surface of the workpiece 10. When the temperature difference U is not equal to zero (U40), the process returns to the step S34 and the internal temperature of the workpiece 10 is measured.

As described above, in the direct heating step according to this embodiment, the output of the heat-transfer member 40 is controlled based on the internal temperature of the workpiece 10 measured by the temperature sensor 23. Note that when the output of the heat-transfer member 40 may be controlled based on the internal temperature of the workpiece 10 measured by the temperature sensor 23, the depth of the insertion of the heat-transfer member 40 and the temperature sensor 23 into the workpiece 10 may also be controlled based on the internal temperature of the workpiece 10.

On the other hand, when the temperature difference U is zero (U=0) in the step S39, the control unit 50 stops the heating of the workpiece 10 by the heat-transfer member 40 as shown in a step S40 in FIG. 7. Specifically, when the heat-transfer member 40 is the superheated-steam nozzle, the spouting (i.e., the injection) of the superheated steam 33 is stopped. When the heat-transfer member 40 is the heater, the electric current to the heater is shut off. Then, the heat-transfer member 40 is pulled out from the workpiece 10. By doing so, the direct heating step is finished.

Note that depending on the material of the workpiece 10 and/or the condition for the subsequent molding process, the set temperature of the workpiece 10 when the temperature difference U is calculated may be different from the set temperature of the workpiece 10 when the temperature difference W is calculated as in the case of the steam heating step. Further, the control unit 50 may determine that both the temperature differences U and W are zero (U=0 and W=0) after confirming that both the temperature differences U and W remain zero (U=0 and W=0) over a predetermined duration as in the case of the steam heating step.

Next, advantageous effects of this embodiment will be described.

The workpiece manufacturing system 100 according to this embodiment includes the steam heating unit 30 and the heat-transfer member 40. Further, after the workpiece 10 is softened by the steam heating unit 30, the heat-transfer member 40 is inserted into the workpiece 10 and the inside of the workpiece 10 is directly heated. In this way, in addition to the heating from the surface of the workpiece 10, the inside of the workpiece 10 can be directly heated. Therefore, the heating time can be greatly shortened.

In the method in which a workpiece 10 is heated by simply bringing superheated steam 33 into contact with the surface of the workpiece 10, it takes a time to raise the temperature of the core of the workpiece 10. In particular, in the case of a workpiece 10 having a large thickness, it takes a long time to heat the workpiece 10 and hence the method is not suitable for mass production. Further, in the case where the thermoplastic CFRP having a low thermal conductivity is contained in the material, it also takes a time to conduct heat to the inside of the workpiece in the method in which the workpiece 10 is heated by using only the thermal conduction from the surface of the workpiece 10.

However, in the workpiece manufacturing system 100 according to this embodiment, halfway through the heating step, the heat-transfer member 40 is inserted into the workpiece 10 and the inside of the workpiece 10 is directly heated. Therefore, since the heating time can be greatly shortened, it can be applied to mass production.

Further, the workpiece manufacturing system 100 according to this embodiment is also applied to the heating of a workpiece 10 that contains, as its material, thermoplastic CFRP into which the heat-transfer member 40 can be inserted. Specifically, there are two types of CFRP, i.e., thermoplastic CFRP and thermosetting CFRP. In this embodiment, after the workpiece 10 containing thermoplastic CFRP is softened, the heat-transfer member 40 is inserted into the workpiece 10 and the inside of the workpiece 10 is directly heated. Further, the control unit 50 performs feedback control according to the difference of the softening temperature of the thermoplastic CFRP. Therefore, in this embodiment, a heating method suitable for the material of a workpiece 10 can be used and hence the heating time can be greatly shortened.

There is a type of thermoplastic CFRP that expands in the plate-thickness direction as it is softened. In such a case, the rate of the heat conduction from the surface of the thermoplastic CFRP to the inside thereof is further lowered. Further, there is a case where an air layer is formed near the surface of the thermoplastic CFRP as it expands in the plate-thickness direction. In such a case, the rate of the heat conduction from the surface to the inside is further lowered. However, in the workpiece manufacturing system 100 according to this embodiment, the heat-transfer member 40 is inserted into the workpiece 10 and the inside thereof is directly heated. In this way, the temperature difference between the surface of the workpiece and the inside thereof is reduced and hence the workpiece 10 can be heated in a short time.

Further, in the workpiece manufacturing system 100 according to this embodiment, the heat-resistant glass 21 is disposed on a side surface of the heating apparatus 1 and the surface temperature of the workpiece 10 is measured through the heat-resistant glass 21 by using a radiation thermometer. Further, the temperature sensor 23 is inserted into the workpiece 10 and the internal temperature of the workpiece 10 is measured. Further, the surface temperature and the internal temperature of the workpiece 10 are monitored, and the outputs of the steam heating unit 30 and the heat-transfer member 40, in particular, the amount of the steam generated by the boiler 31, the output by which steam is heated in the superheated-steam generator 32, the amount of the superheated steam spouted out from the superheated-steam nozzle, the output of the heater, and the like are feedback-controlled based on the monitored the surface temperature and the internal temperature. Therefore, it is possible to detect unevenness in the temperatures in the surface and the inside of the workpiece 10 and thereby to optimize the temperatures. In this way, the heating time can be greatly shortened. Further, since the energy required for the heating can be optimized, energy consumption can be reduced.

The method for manufacturing the workpiece 10 according to this embodiment includes the steam heating step and the direct heating step. Further, after the workpiece 10 is softened in the steam heating step, the heat-transfer member 40 is inserted into the workpiece 10 and the inside of the workpiece 10 is directly heated in the direct heating step. In this way, since the direct heating can be performed halfway through the steam heating step for the workpiece 10, the heating time can be greatly shortened.

### MODIFIED EXAMPLE 1

Next, a modified example 1 of the embodiment will be described.

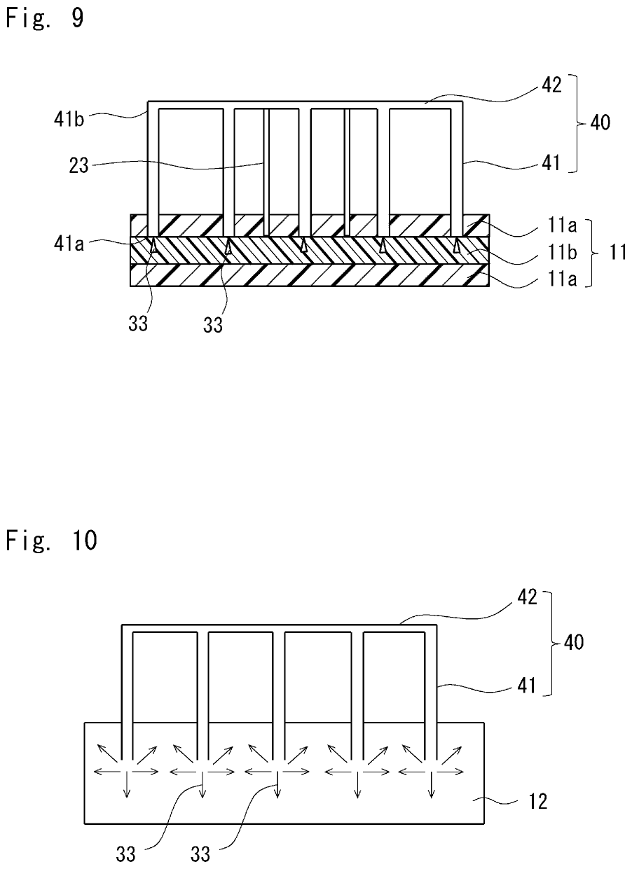

FIG. 9 shows an example of a state in which the heat-transfer member 40 is inserted into a workpiece 10 in a method for manufacturing a workpiece according to the modified example 1 of the embodiment. As shown in FIG. 9, the workpiece 11 according to this modified example includes a softened layer 11a and a hardened layer 11b in the direct heating step.

In this modified example, the insertion parts 41 of the heat-transfer member 40 are inserted into the softened layer 11a of the workpiece 11 and the hardened layer 11b of the workpiece 10 is directly heated. In this way, the hardened layer 11b inside the workpiece 10 is changed into the softened layer 11a. Further, the heat-transfer member 40 is further inserted into the part that has changed into the softened layer 11a.

As described above, in this modified example, since the heat-transfer member 40 can be further inserted into the part that has changed into the softened layer 11a and hence the inside of the workpiece 10 can be directly heated, the heating time can be further shortened. When the heat-transfer member 40 is further inserted into the part that has change into the softened layer 11a, the temperature sensor 23 may also be further inserted. In this way, the internal temperature of the workpiece 10 can be accurately measured.

### MODIFIED EXAMPLE 2

Next, a modified example 2 of the embodiment will be described.

FIG. 10 shows an example of a state in which the heat-transfer member 40 is inserted into a workpiece in a method for manufacturing a workpiece according to the modified example 2 of the embodiment. As shown in FIG. 10, a workpiece 12 in this modified example includes CFRP that expands as it is softened.

There are two types of CFRP containing a thermoplastic resin depending on the material of the thermoplastic resin. That is, there are CFRP that expands as it is softened and CFRP that does not expand when it is softened. The CFRP that expands as it is softened gradually expands from the surface as it is softened from the surface. When such CFRP is heated, its structure becomes a sponge-like structure as it expands. Therefore, the density of the workpiece 10 containing the CFRP decreases and hence the thermal conductivity to the inside of the workpiece 12 decreases. Further, the distance from the surface of the workpiece 12 to the inside thereof also increases as the CFRP expands. Therefore, in the CFRP that expands as it is softened, it takes a long time to heat the inside of the workpiece when it is heated only from the surface thereof by the superheated steam 33.

To cope with this problem, in this modified example, the heat-transfer member 40 is inserted into the workpiece 12 and the inside of the workpiece 12 is directly heated. Therefore, even in the CFRP that expands as it is softened, every corner of the workpiece 12 can be filled with the superheated steam 33 and hence the heating time can be further reduced.

Embodiments of the present disclosure have been explained above. However, the present disclosure is not limited to the above-described configurations, and they can be modified without departing from the technical idea of the present disclosure.

For example, in the steam heating step and the direct heating step according to this embodiment, both of the heating steps are finished when both of the temperature difference U between the set temperature and the surface temperature of the workpiece 10 and the temperature difference W between the set temperature and the internal temperature of the workpiece 10 become zero. However, present disclosure is not limited to such an example. Depending on the material of the workpiece 10 and/or the condition for the subsequent molding process, the heating of the workpiece 10 may be finished when only one of the temperatures reaches the set temperature. Further, depending on the material of the workpiece 10 and/or the condition for the subsequent molding process, the set temperature in the steam heating step may differ from the set temperature in the direct heating step.

Further, the heat-transfer member 40 includes the insertion parts 41 that are opposed to the workpiece 10 and the lattice-pattern connection part 42. However, the heat-transfer member 40 is not limited to such an example. The heat-transfer member 40 may have any configuration as long as it can be inserted into the workpiece 10 and can directly heat the inside of the workpiece 10. Further, the direction in which the insertion parts 41 extend does not have to be the vertical direction. That is, the insertion parts 41 may extend in any direction as desired. Further, all the insertion parts 41 do not have to extend in the same direction.

The chamber 20 to which the steam heating unit 30 is connected is not limited to the heating furnace. For example, the chamber 20 may be space inside a molding die.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A workpiece manufacturing system comprising a heating apparatus configured to heat a workpiece containing a carbon fiber reinforced plastic containing a carbon fiber and a resin as its material, wherein
the heating apparatus comprises:
a steam heating unit configured to heat at least a part of the workpiece including its surface to a temperature higher than a softening temperature of the carbon fiber reinforced plastic by bringing superheated steam into contact with the surface of the workpiece; and
a heat-transfer member configured to be inserted into the part of the workpiece including the surface whose temperature has reached the softening temperature and thereby directly heat an inside of the workpiece.

2. The workpiece manufacturing system according to claim 1, wherein the heat-transfer member comprises a superheated-steam nozzle configured to spout out the superheated steam.

3. The workpiece manufacturing system according to claim 1, wherein the heat-transfer member comprises a heater.

4. The workpiece manufacturing system according to claim 1, further comprising:
a thermometer configured to measure a surface temperature of the workpiece;
a temperature sensor configured to measure an internal temperature of the workpiece; and
a control unit configured to control an output of the steam heating unit and the heat-transfer member based on the surface temperature and the internal temperature, wherein
the control part controls a depth of insertion of the heat-transfer member and the temperature sensor into the workpiece based on the internal temperature.

5. A method for manufacturing a workpiece, comprising a heating step of heating the workpiece containing a carbon fiber reinforced plastic containing a carbon fiber and a resin as its material, wherein
the heating step comprises:
a steam heating step of heating at least a part of the workpiece including its surface to a temperature higher than a softening temperature of the carbon fiber reinforced plastic by bringing superheated steam into contact with the surface of the workpiece; and
a direct heating step of inserting a heat-transfer member into the part of the workpiece including the surface whose temperature has reached the softening temperature and thereby directly heating an inside of the workpiece.

6. The method for manufacturing a workpiece according to claim 5, wherein in the direct heating step, a superheated-steam nozzle configured to spout out the superheated steam is inserted as the heat-transfer member.

7. The method for manufacturing a workpiece according to claim 5, wherein in the direct heating step, a heater is inserted as the heat-transfer member.

8. The method for manufacturing a workpiece according to claim 5, wherein
in the steam heating step, a temperature of the superheated steam is controlled based on a surface temperature of the workpiece measured by a thermometer, and
in the direct heating step, an output of the heat-transfer member is controlled based on an internal temperature of the workpiece measured by a temperature sensor, and a depth of insertion of the heat-transfer member and the temperature sensor into the workpiece is also controlled based on the internal temperature.
